(19) United States
(12) Patent Application Publication
(10) Pub. No.: US 2012/0101803 A1
(43) Pub. Date: Apr. 26, 2012

(54) FORMALIZATION OF A NATURAL LANGUAGE

(76) Inventors: Ivaylo Popov, Sofia (BG); Krasimir Nikolaev Popov, Sofia (BG)

(21) Appl. No.: 12/740,106

(22) PCT Filed: Nov. 12, 2008
(86) PCT No.: PCT/BG2008/000022

§ 371 Date: Sep. 16, 2010

(30) Foreign Application Priority Data
Nov. 14, 2007 (BG) 019996

(51) Int. Cl. G06F 17/28; G06F 17/27

(52) U.S. Cl. 704/2; 704/9; 704/E11.001

(57) ABSTRACT

It is disclosed a method for formalization of a natural language allowing creation of an unambiguous model of a natural language text. It is determined the basic notions for entities that are named by a natural language and for each basic notion it is attached an unique number or name and a description, in addition it is attached a list of words which can name the basic notion for each used natural language. The unambiguous model uses only basic notions. In this way it is possible a machine to interpret the unambiguous model and to input knowledge and data in a base or to make a text generation in another natural language using the unambiguous model. Also it can be generated a text in artificial language such as a program language.

### TECHNICAL FIELD

The invention is about input of knowledge in a machine using a natural language. It can be used as a machine translator of a natural language.

### BACKGROUND ART

The most popular schemes are those in which machines interpret defined set of words in a natural language—all artificial languages are of that type. There are attempts to define the grammatical meanings of the words. There are developments in which it is given the subject field for a given text and in that way it can also be defined the preferred meaning of a word and therefore to fulfill better results, for example in a machine translation. There are attempts to define the meaning of a word from the other words in the text and from the statistics for usage of the word among other words. There are attempts to set digital values from the same set to the words in a given natural language and to other natural language, so that the words from both languages with one and the same appropriated value to have alike meaning.

### DISCLOSURE OF INVENTION

### Technical Problem

It is not solved the problem of unambiguous interpreting of a natural language from a machine, which is a hindrance for input of knowledge and data in the machine using a natural language. A machine cannot be used for an official translation of a document because it is not a reliable way for a translation. It cannot be created a text of a natural language which has an unambiguous interpretation from different people but it is really important while writing textbooks or patent applications. A computer cannot be programmed using a natural language because one sentence of a natural language has many possible meanings from a formal point of view, so grammatically true sentences can be interpreted in different ways. The existing human knowledge cannot be used optimally because there is no formalized way in which a machine interprets directly knowledge written in a natural language.

### Technical Solution

The interpretation of a natural language always includes building of a machine model of interpreted knowledge. The text in a natural language is interpreted by different means so that it can be defined the grammatical parts of speech, the meaning of the sentence and of the words in it. The problem is that there is no backward relation and a person cannot have influence on the formed model. This is that because there is no base for comparison between the model and the text in a natural language. So the model is also a structure which cannot be interpreted in one way only. Technical essence of the offer is method for creating an unambiguous model. The model formed in this way can be interpreted in one unique way only.

The method has five steps.

In the first step it is made study of a grate number of languages as the purpose is to be defined the basis of notions that the human race uses. It has to be taken into consideration that a word in a natural language is not a basic notion. The basic notion is denotation of some entity or action. Usually with one and the same word in a natural language is denoted several different basic notions, so that the words have different meanings. The offer from the level of technics is to denote ‘sluntze=1’ (‘sluntze’ in English means sun) and ‘sun=1’ can contribute to making a machine translation, but it cannot contribute to making a meaningful unambiguous translation. In this kind of systems the result from the translation can be of that kind: ‘User rights=prava na narkomana’ (‘prava na narkomana’ is in English the rights of drug addicted), but in fact in the given context ‘user rights’ means the rights of the customer. This kind of numerated words creates just an intermediate language with ambiguous meaning. The offer is to numerate the entities but not the words. The entities according to the method have unique names. The names can be numbers, but they can also be words from a widely spread natural language. It has to be mentioned that a given word in a natural language can be used only in one way for denoting of an entity. In that way ‘sluntze’ (‘sluntze’ in English is sun) can have only the meaning—star, and for all the other meanings of the word ‘sluntze’ it must be chosen other words. It should be understood that this king of naming the meanings influences in no way on the natural language. The entities according to the method are characterized with their descriptions. The descriptions of the entities are given in a natural language in the same way which it is done in a dictionary in a natural language. Each entity has a list of words with which it can be named in a natural language—something like a Dictionary Thesaurus but for entities not for words.

The structure about an entity that has an unique label—name or number, a description, and a list of words representing said entity in a natural language is further called basic notion.

The second step of the method is to be created the model of the text in a natural language using only basic notions . In this step of the method they are used all applicable methods from background art which gives the ability to be defined grammatical and semantic meanings of the words in the text and to be created the model. During the creation of the model it can be used global statistics for the usage of words in their different meanings or a local statistics for each user of the method, It can be used similar texts with already specified meaning of the words. Human translations of a given texts from one language into another can also be used for defining the basic notions used in the text in a natural language as the used words in translations are explored and they are compared to words from the original text considering their meanings.

The third step of the method is a backward relation, to this step the created model in the second step is used as a base for generating a text in the same natural language in which the original text is. An operator has the ability to make changes in the generated model using computer program so that the generated model meets his expectations for understanding of the text. This can be made with a direct change in the model as it is worked directly with represented entities, for example with a tree of the relations between the entities. This manner of work requires serious training. In another realization the change in the model can be done by the means of attempt to explain to the computer which entity should be changed. It is possible the original text to be compared with the generated text and to mark the differences between the original and the generated text. For each marked word from a thesaurus dictionary it outputs a list of synonyms as it is possible to filter those synonyms that have been rejected as some with unappropriated meaning. The operator chooses from the list with synonyms and the process repeats in real time—so there is new generation and there is a possible new correction. The choice of synonyms however not always is enough for defining of a given entity. So it can be considered some means for change of the interpretation of the relationship between two basic notions in a given text. In that way, a relationship can be made using visual means for marking and identification. For example, it can be specified which the subject in the sentence is or which the mean is and which the explanation is. It is possible to be created a mean by which it is indicated the tense relations in the text. It is possible to be created means to change the external characteristics of a text so that the interpretation and generation can be managed easily. For example, it can be pointed the cases in which the true interpretation distinguishes from the standard one like playing with words and sarcasm—in that way it must be given both interpretations: the standard one and the modified one, according to the external characteristic, and they become part of an unambiguous model. It can be created many means of that kind aiming to make it possible for a medium educated person to show to the computer what he/she has in mind. The aim is to be achieved an unambiguous model which represents the meaning of the text in the most accurate way.

The forth step of the method—The generated unambiguous model of the text in a natural language is attached to the file containing the text in the natural language. This makes unambiguous interpretation of the text in the natural language which is useful in patent applications and in machine translation. When a text in a textbook is created using the method with attaching unambiguous model it is possible the computer program to generate an explanation in a random level of complexity as it uses the definitions of the entities used in the text and as well a recursive usage of the definitions of the entities used when defining the entities in an upper level.

Fifth step of the method is usage of unambiguous models of texts in natural language for machine learning and for creation of concepts and theories by a machine using the base of formalized knowledge got from the unambiguous models of the texts in a natural language.

### ADVANTAGEOUS EFFECTS

The application of the invention can be in a machine translation, in searching for knowledge, where searching is not in the base of words the text contains, as it is in the today's level of technics, but the searching is of similar unambiguous models of the searched text. It is possible to be made also a search using analysis of unambiguous models of the texts—so the explorer can answer a question like searching for information about transferring property to foreign citizens according to the Bulgarian laws.

### BEST MODE

Exemplar Realization of the First Step of the Method

Using a computer program it is determined the basic notions of the language and it is examined the list of each word's synonyms in the examined natural language. The definitions of each word of the language which are given in the dictionary are compared to the definitions of its synonyms also given in the dictionary. Comparison of the definitions is made using simple comparison and searching in similar texts. The aim is to define the different meanings of a given word according to the synonyms of each meaning. In this way using comparison between the definition of each word with the definition of its synonym, given in the dictionary, are defined the relevant similar texts from both definitions—they form different meanings, named in this method “entities”. The definition of an entity is usually formed by similar texts in the definitions of both synonyms. When such an entity is found it is made a check in the database if it is not already registered a similar entity while comparing the descriptions of the registered entities with the description of the new entity. If the new entity is not already registered in the database, it is registered.

After automatic forming of the base of entities with their descriptions, experts are offered to name the entities and to specify their descriptions. To the entities it is given a list of words which can define them in certain conditions which depend on the text containing the word and on the external characteristic of the text like if the text is scientific or if the text is playing with words and so on. It is possible when the base of all entities is already available to be made the description of each entity using an unambiguous model of the description in a natural language. This can be done by philologists who create an unambiguous model of the entity's description using the automatically formed description in a natural language as they use the basic notions of the language. After finding the basic notions in a natural language, the next natural language uses the formed base of basic notions. It is easier philologists to define how in a certain language they can name the registered entities and eventually the set of entities which must be added to the base additionally. When an entity is added to the base philologists who look after the accordance of the natural languages should be informed so that they can give a proper name of the new entity, they are in charge of. It is possible the name of the new entity to be descriptive.

It is possible exploration of a second and so on natural language to be automatized. The same procedure is set as this in the first explored language. It is made a new base from registered entities. The names which an entity from the new base can have are words from the second language. From a second language to first language dictionary it is found the possible translations of each name of an entity of the second base. For each translation—a word from the first language from the first base, it is taken out the entities which can be named with this word. It is made pseudo-translations of the description of the entity in the second language as all the combinations of substitutions of each word of the description with all possible translations in the first language are generated. Pseudo-translations of the description of the entity from the second language are compared to the descriptions of the taken out entities of the first base. It is found and marked the best accordance. Each found accordance in this way should be approved by a philologist. After approval of an accordance the entity is erased from the second base. The list of names for this entity in the second language is marked that it is in the second language and it is added to the entity of the first base. After processing all accordances, those entities that are still in the second base are either registered as new entities in the first base or a human finds their accordance in the first base.

In official documents it must be achieved unity of the generated text in a natural language from the unambiguous model. This can be done at the cost of simplification of the generated text so in spite of the fact that it is possible from a language point of view to have multiple generations of a text in a natural language which have the same meaning and to represent the same knowledge holding by the unambiguous model to be achieved an unique generation. It is the job of the philologists to add to the unambiguous model so much characteristics of the text that are necessary for achieving an unique generation.

Such an approach is especially important for a translation of official documents from one language into another and particularly for patent applications.

On the other hand, in translations of literature it is better to have multitude of generations of texts in a natural language from the unambiguous model and to be chosen the best one for a construction of the concrete language using statistical data from literature in the particular language.

Exemplar Realization of the Second Step of the Method

The text can be presented as a list of trees and each tree is one sentence of the text. It is possible to have relationships between the separate frees. Each element of a tree is an object which has additional characteristics which are extracted automatically from the text or are been added manually by an operator. A part of these characteristics are relationships between each element of the tree and the other elements of the tree. Some of the elements of the tree representing a sentence in the text, for example the pronouns, can have a relationship with the elements belonging to other frees. The order of the trees in the list is of an importance. It represents the order of the sentences in the original text and eventually in the generated text from the unambiguous model.

Exemplar Realization of the Third Step of the Method

It is created a superstructure of a text editor with additional abilities to help the changes in the automatically formed unambiguous model of the text to be made easily. For example the screen to be divided into three areas. First area is for the whole original text—an ordinary text editor. The second area is for a backward relationship when the unambiguous model has been created. In it it is the machine generated text of the processed sentence of the text. When holding the pointer of the mouse over a certain word from the machine generated text it is shown as a hint the description of the basic notion which is named with that word. The same sentence is marked properly in the original text. The third area is a tools bar for changing the unambiguous model which is applicable on the second area. These tools include the change of the the interpreted entity as giving a synonym of the word which is a synonym of another entity named by the word in hand. It is possible as a hint to be given the description of the basic notion named by the synonym. It includes means to chose a characteristic of the text such as playing with words, a jest, poetry or scientific text. It includes defining the exact meanings for substitution of the used pronouns, for example who in fact He, She is or which It is. The exact meaning can be defined within the range of the whole text as it sets the relationship given with a definite pronoun to the previous sentences in the text. The text is examined consecutively from the beginning to the end as it is given all needed characteristics and relationships so that it is formed an unambiguous model. A sentence is processed while a machine generation make a text which at least has the same meaning as the original text. The process consists of set of changes and generations.

Exemplar Realization of the Forth Step of the Method

The generated unambiguous model for a given text is attached to the original file. Such an attachment can be made by many ways. It is possible in the original file to be added a link to the unambiguous model of the text. It is possible the file in the original text and the file of the unambiguous model to be written in one archive package. It must have in mind that in a general text in a natural language is possible to have multiple formed unambiguous models. This is that way because the multitude of interpretations of a given text in a natural language is filtered by a human—operator, who uses his/her own understanding so that he/she translates the text in the natural language in an unambiguous machine model. So it is possible to foresee attaching of a text in a natural language to many unambiguous models. When it is about a patent application it is naturally the object of protection to be only one unambiguous model of the text of the application the same as it has been applied.

Exemplar Realization of the Fifth Step of the Method

The unambiguous models of the texts of a natural language can give in to a formal processing. It is possible to be created different kinds of representation of the unambiguous model which are proper for different kinds of machine processing. Unambiguous models can be defined as a new kind of computer software because they can be a subject to formal interpretation. In this way it can be realized a machine learning as it is dragged out facts and relationships from the unambiguous models of the texts in a natural language. It can be applied unambiguously and formally all mechanisms which are studied in the artificial intelligence. In this way the traditional software will be replaced with expert systems which contact with ordinary user in a natural language with easy addition of an unambiguous model and which give services for generation of applied software in accordance with the needs of the user.

### INDUSTRIAL APPLICABILITY

The disclosed methods are executed by a special computer software. A computer program can be used by professionals to create and support the database with basic notions used by the human race. Another computer software can be used by all users, those creating and using unambiguous models of natural language texts. The last computer software must be able to make a connection to the database with basic notions.

The methods can be used in machine translation from a natural language to another natural language or to artificial language e.g. program language. The methods can be used in searching and processing natural language.

Especially the application of the method is important in the field of patent system not only for unambiguous defining of the object of the protection and the possibility for automatized search and investigation but also for the possibility of a machine processing in the newest and valuable knowledge of the humanity which can be a mason for automatic generation of a new knowledge for the humanity.

1. Formalization of a natural language that enables a machine interpretation and generation of a text in natural language by creating a machine model of the text, characterized by creation of an unambiguous model of the text in natural language which can be interpreted in one and only in one way following these steps:
it is using previously determined basis of notions which the humanity uses so that the basis of notions includes all the basic notions which are unique denotations of an entity or action and they are
unique label—number or word
and they have
description in a natural language,
and they have
for each natural language which is going to be processed using the method, an attached list of words, which name is in the given natural language;
a computer analyses the text in the natural language and as using the basis of notions and in particular the lists of words which name a certain basic notion in the given natural language it finds used basic notions and together with a grammatical and language analysis it makes first unambiguous model of the text in a natural language;
a computer uses the first unambiguous model to generate again the text in the same natural language;
a computer compares the generated text in a natural language from the first unambiguous model to the original text and it marks the differences;
an operator uses a computer program with which he/she can see the basic notions, chosen by the computer and to change them, also he/she can determine relationships and characteristics of the text which the computer has made difficult finding like which parts of speech are, like for a certain action in which tense it is in a complex sentence or when it is about actions in two adjacent sentences, like what exactly a pronoun substitutes, like which part of the speech with which is connected and how;
a computer uses the operator's remarks and the first unambiguous model and generates a second unambiguous model;
a computer uses the second unambiguous model to generate again the text in the same natural language; a computer compares the generated text in a natural language from the second unambiguous model with the original text and it marks the differences;
an operator makes corrections and the steps interpretation-generation-correction are repeated while the operator accepts that the recently generated from the computer unambiguous model presents the meaning of the text in a natural language well enough.

2. Formalization of a natural language, according to claim 1, characterized also by the step where the formed unambiguous model of the text in a natural language is attached to the same text by a link or by putting the file with the text in a natural language together whit the file containing its unambiguous model in one archive package.

3. Formalization of a natural language, according to claim 1, characterized also by the step where the unambiguous model of the text in a natural language is used in machine processes like searching, extracting facts and relationships, also like in deteraiining a text in its legal meaning.

4. Formalization of a natural language, according to claim 1, characterized also by the step where it uses comparison between the human translation of the original text of one or more languages with purpose to determine exactly and automatically used basic notions, parts of speech and relationships between them, the gender, the number, the tense of the action and tense relationship with other actions.

5. Formalization of a natural language, according to claim 1, characterized also by the step where it generates from unambiguous model of a natural language text a text in an artificial language.

6. A method for determining the basic notions which the humanity uses, necessary for execution of the method given in claim 1, characterized by the following steps:
for each word hi a natural language, a computer finds and extracts its synonyms in a computer dictionary of synonyms;
for each pair of word-synonym a computer compares the descriptions given in a dictionary for the word and for the synonym;
for each two similar texts which contain a given percentage of one and the same words or words-synonyms for a given text, it is supposed that they describe a basic notion;
a computer outputs a list of supposed basic notions and the descriptions which have made that decision;
it is checked in the data base for each supposed basic notion if it is not already registered as it compares discovered in the previous step similar texts to the descriptions of the basic notions in the base and if there is a given percentage of words or words-synonyms it can be considered that the basic notion is already registered and the found description of the basic notion is outputted by the computer and also the other two similar descriptions which are the cause for the search;
an operator checks if the text with outputted by the words coincidence way have a semantic coincidence and if it found such a coincidence he/she decides that the given basic notion is already registered and he/she only adds to the registration one or both words-synonyms which name the basic notion in a certain natural language;
if a given basic notion is not found in the data base, it is added as from the two similar texts is chosen one or the operator specifies the description.

7. A method for addition of a new natural language to the formed base of basic notions, characterized by the following steps:
it is used the method according to the claim 6 for the new language and it is formed second base of basic notions;
from a dictionary from a second language to the first (which already is in the base) are found the possible translations of each name of a basic notion from the new base;
for each translation-word from the first language are extracted the basic notions which can name that word;
it is made pseudo-translations of the description of the basic notion in the second language as it is generated all combinations of substitutions of each word from the description with all possible translations in the first language;
pseudo-translations of the description of the basic notion in the second language are compared in percentage of one and the same words or words-synonyms to the descriptions of the extracted basic notions from the first base;
it is found the best accordance and it is marked; each found in this way accordance is approved by an operator who decides if found similar descriptions by similar words have semantic accordance;
after approval of the accordance in the second base the basic notion erases, and the list of names of the basic notion from the second language marks that it is in the second language and it adds to the basic notion from the first base;
after processing of all accordances, those basic notions that are still in the second base are registered as new basic notions in the first base or an operator finds their accordance in the first base.

8. (canceled)

9. Special software according to claim 11, characterized also by the ability to generate explanations in a random level of complexity as using descriptions of the basic notions used in the text, as well as to use recursively the descriptions of the basic notions used for determining of the basic notions in an upper level and to substitute the basic notion with its description.

10. Special software according to claim 11, characterized also by the ability to search in or to process the unambiguous model instead of search in or process the text in the natural language, having in addition the ability to represent the results from the search or processing by a generation of a text in a natural or artificial language or to represent the results as an accordance in the text in a natural language.

11. Special software for implementation of the method according to claim 1, which has the ability to edit text and characterizes with the following abilities:
to can open one connection to the database, where is written previously prepared set of basic notions;
to generate unambiguous models of a text in a natural language using previously prepared basic notions for the given natural language;
to generate from an unambiguous model a text in a natural language;
to be able to set in which natural language to be made the generation from the unambiguous model;
to mark relevant sentences in the original and in the generated texts;
to mark the differences between the relevant sentences in the original and in the generated text;
to represent the description of the basic notion which the computer has chosen for a certain word in a natural language as this representation is made as the words are pointed in the original text or in the text generated according to the unambiguous model;
to be able an operator to change directly or as indicating a synonymous a basic notion which the computer was attached to the word from the text in a natural language;
to be able the operator to indicate the parts of speech and relationship from one part of speech to another;
to be able the operator to indicate the tense relationships between the actions in a complex sentence or the actions in two adjacent sentences;
to be able the operator to indicate what it is substituted by a particular pronoun;
to be able the operator to indicate the external characteristics of the text such as which the subject area of the text is, if it is irony, sarcasm or playing with words.
